(19) United States
(12) Patent Application Publication
(10) Pub. No.: US 2011/0221676 A1
(43) Pub. Date: Sep. 15, 2011

(54) OPTICAL MOUSE WITH TOUCH SENSITIVE TOP

(75) Inventor: YUNG-LUNG LIU, Ta Ya Shiang (TW)

(73) Assignee: Sunrex Technology Corp., Ta Ya Shiang (TW)

(21) Appl. No.: 12/722,400

(22) Filed: Mar. 11, 2010

(51) Int. Cl. G06F 3/033

(52) U.S. Cl. 345/166

(57) ABSTRACT

An optical mouse with touch sensitive top includes a curved top including front clickable right and left buttons and a touch sensitive member extending rearward from the buttons, the touch sensitive member including a plurality of virtual buttons which are sensitive to touch; and a capacitive sensor assembly under the touch sensitive member and including first and conductive layers each being flexible and curved. In addition to button clicking and wheel scrolling, a user may press the virtual button for computer operation similar to a touchscreen operation.

### BACKGROUND OF THE INVENTION

1. Field of Invention

The invention relates to computer input devices and more particularly to an optical mouse having a portion on a curved top being touch sensitive so as to incorporate characteristics similar to that of a touchscreen thereinto in addition to button clicking and wheel scrolling.

2. Description of Related Art

Conventionally, a user may use a mouse to move around on a desk and depress a button to operate a computer. No characteristics similar to that of a touchscreen are provided by the typical mouse. Unfortunately, this can greatly reduce applications of the mouse especially without the characteristic of allowing a user to manipulate a mouse by touching. Moreover, tops of typical computer mouses are not provided with virtual buttons or numbers. Thus, a user cannot manipulate a typical mouse by touching the virtual buttons or numbers. This is not desirable.

Recently, a type of mouse called “Magic Mouse” was manufactured and sold by Apple Inc. It substantially has a flat top. It is a multi-touch mouse with a plurality of virtual buttons on the top. A user may touch the top to enable one of the virtual buttons to move a pointer on the screen or scroll the screen vertically. However, negative reactions are that, for example, a user may lose the feeling of depressing a button of a conventional mouse (i.e., familiar clicking sound) since no conventional buttons are provided on the “Magic Mouse” top. This advancement of the art is not desirable because it is inconvenient in use or even a user does not know how to manipulate the mouse.

Thus, it is desirable to provide a novel optical mouse incorporating characteristics of similar to that a touchscreen into its top in addition to button clicking and wheel scrolling in order to overcome the inadequacies of the prior art.

### SUMMARY OF THE INVENTION

It is therefore one object of the invention to provide an optical computer mouse having a portion on a curved top being touch sensitive so as to incorporate characteristics similar to that of a touchscreen thereinto in addition to button clicking and wheel scrolling.

To achieve the above and other objects, the invention provides an optical computer mouse comprising a casing comprising a curved top including a front clickable left button, a front clickable right button parallel to the left button, and a touch sensitive member extending rearward from the right and left buttons, the touch sensitive member including a plurality of virtual buttons which are sensitive to touch; a capacitive sensor assembly mounted under the touch sensitive member and comprising a first conductive layer and a second conductive layer, each of the first and second conductive layers being flexible and curved; a PCB (printed circuit board) comprising an optical sensor electrically connected thereto, the optical sensor being responsive to diffuse light reflected from a desk top with the optical computer mouse rested thereon; a scroll wheel mounted on the PCB and electrically connected thereto, the scroll wheel projecting out of the casing so that the scroll wheel is operable to rotate to move a mouse pointer on a screen of a computer system being operated by the optical computer mouse; two contact switches mounted on the PCB and electrically connected thereto, the contact switches being disposed under the right and left buttons respectively so that either one of the right and left buttons is operable to press to create an output by contacting either contact switch; a base releasably secured to the casing to assemble the optical computer mouse; and an optical element mounted on a top of the base.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of optical mouse according to the invention;

FIG. 2 is an exploded view of the optical mouse shown in FIG. 1; and

FIG. 3 is a longitudinal sectional view of the optical mouse shown in FIG. 1 showing its clicking operation.

### DETAILED DESCRIPTION OF THE INVENTION

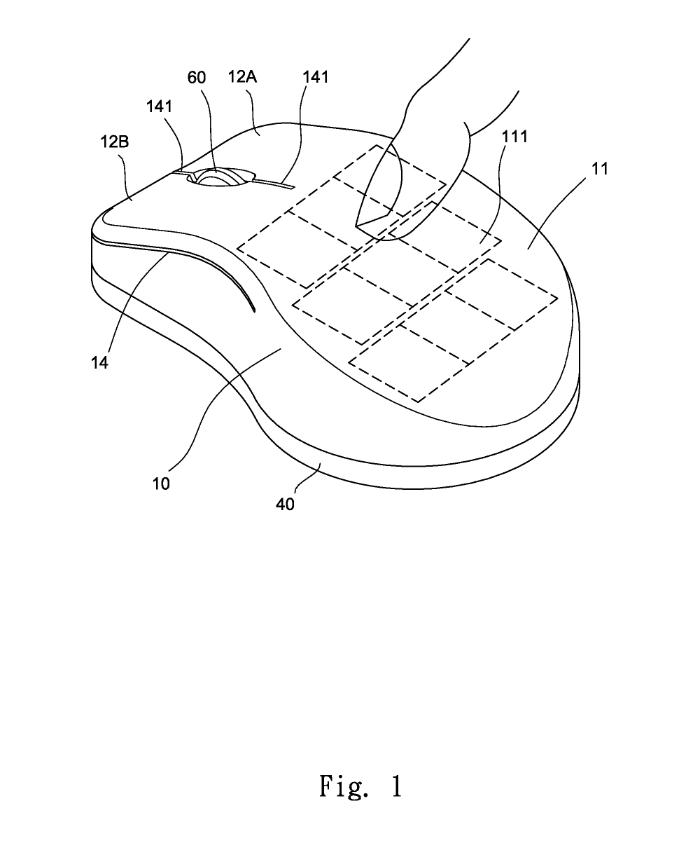

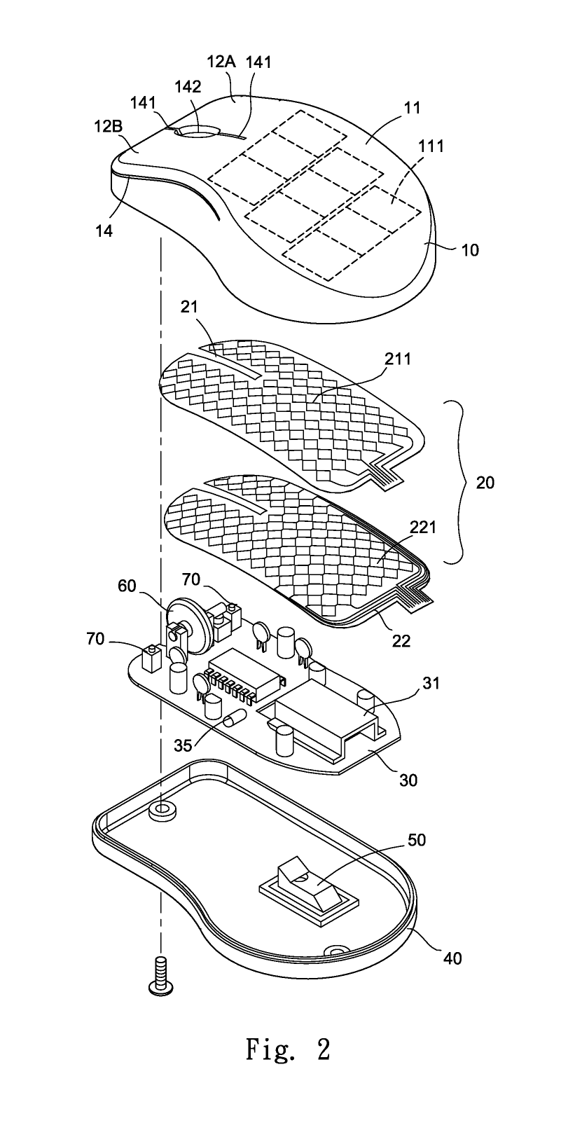

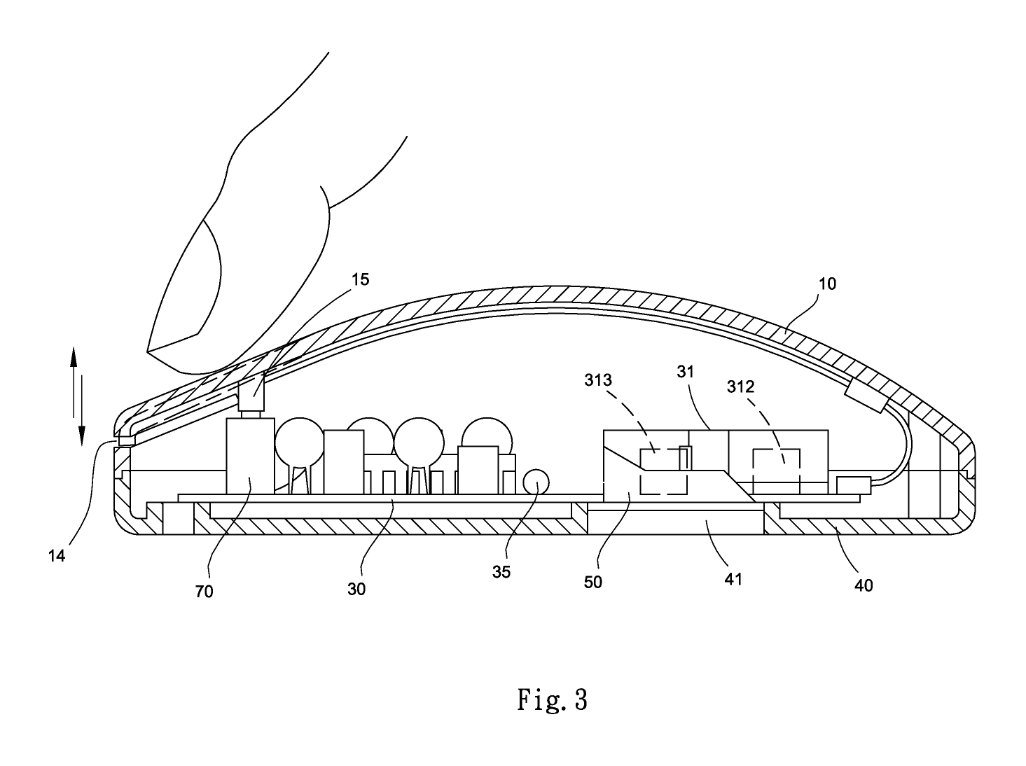

Referring to FIGS. 1 to 3, an optical mouse in accordance with a preferred embodiment of the invention is shown. The optical mouse is a wireless optical mouse and comprises the following components as discussed in detail below.

A casing 10 comprises a curved top including two front clickable buttons (e.g., right button 12A and left button 12B) and a touch sensitive member 11 extending rearward from the buttons 12A, 12B. On the touch sensitive member 11 there are provided with a plurality of virtual buttons 111 each printed with and representing a unique function key or number and being sensitive to finger touch.

The right button 12A and the left button 12B are parallel each other and are separated by an elongated slit 141. An elliptic opening 142 is formed on an intermediate portion of the slit 141. A substantially U-shaped trough 14 when viewing from the top is formed to separate a lower front portion of the casing 10 from an upper front portion thereof (i.e., the right button 12A and the left button 12B). Each of the right button 12A and the left button 12B is provided with a downward peg 15. Hence, a user may press either one of the right button 12A and the left button 12B to lower the peg 15 in a mouse button operation as detailed later.

A capacitive sensor assembly 20 is capacitive in nature and comprises an upper first conductive layer 21 including a plurality of first sensor zones 211 arranged in a plurality of rows, and a lower second conductive layer 22 including a plurality of second sensor zones 221 arranged in a plurality of rows. Each of the first conductive layer 21 and the second conductive layer 22 is flexible and curved, and is formed of conductive film. The capacitive sensor assembly 20 is mounted under the top of the casing 10 (i.e., both the first and second conductive layers 21, 22 being under the virtual buttons 111).

A PCB (printed circuit board) 30 comprises an optical sensor 31 being electrically connected thereto. The optical sensor 31 comprises an LED (light-emitting diode) 312 as a light source, and a light sensitive member 313 which is responsive to diffuse light reflected from the desk top and impinging thereon.

A scroll wheel 60 is provided on a central portion of a front end of the PCB 30 and is electrically connected thereto. The scroll wheel 60 projects out of the elliptic opening 142 so that a rotation of the scroll wheel 60 can move a mouse pointer on the screen as known in the art.

Two contact switches 70 are spaced from both sides of the scroll wheel 60 respectively. Each of the contact switches 70 is disposed under the peg 15 by a predetermined distance (i.e., stroke). Hence, a pressing of either one of the right button 12A and the left button 12B will move the peg 15 downward until being stopped by the contact switch 70. As a result, a signal (i.e., output) is generated to be processed by the PCB 30 as known in the art.

A base 40 is threadedly secured to the casing 10 to form a complete mouse with the above components contained therein or thereon. The base 40 comprises a rectangular opening 41. An optical element 50 for guiding and focusing light is provided on the opening 41. The optical element 50 is well known in the art and a detailed description thereof is therefore deemed unnecessary.

Operation of the invention will be described in detail below. A user may use a mouse to move around on a desk. Light emitted by the LED 312 passes the optical element 50 and the opening 41 to reach the desk top. Light then reflected from the desk top to the light sensitive member 313 via the optical element 50. An output is created by the light sensitive member 313. The output is then processed by the PCB 30 to convert into a digital representation useable to move a cursor a precise distance toward a desired direction on a computer screen.

The user may also depress one of the right button 12A and the left button 12B until the peg 15 is stopped by the contact switch 70 (i.e., end of a stroke). Note that a single clicking is discussed herein as an exemplary example. An output is created and is then processed by the PCB 30 to open or launch a selected file pointed by the mouse pointer or call up an image pointed by the mouse pointer for further information.

Moreover, a user may press one of the virtual buttons 111 by the finger. In response, capacitance of the depressed virtual button 111 is changed. Likewise, an output is created and is then processed by the PCB 30 to open or launch a selected file pointed by the mouse pointer or call up an image pointed by the mouse pointer for further information. This is a multi-touch characteristic of the invention.

Preferably, the casing 10 is formed of an optically transmissive material so that a user can manipulate the mouse of the invention in a dark environment. Moreover, the capacitive sensor assembly 20 is preferably made of an optically transmissive material. Further, an additional light source 35 is mounted on the PCB 30. As a result, the casing 10 is rendered as one capable of emitting background light so that a user may manipulate the mouse of the invention in a dark environment.

The invention has the following advantages. The curved casing top is ergonomic. The left and right buttons are clickable. Hence, a familiar clicking sound is generated by depressing either button. Screen scrolling is provided by rotating the scroll wheel. A multi-touch feature is provided. Each virtual button represents a function key or number and is sensitive to touch. An optical sensor is provided on a lower portion in the casing so that moving a cursor a precise distance toward a desired direction on a computer screen can be carried out in response to mouse movement. Background light can be seen on the casing top. This is particularly helpful for operating a computer in a dark environment, or for the elderly or those having poor eyesight when operating a computer.

While the invention herein disclosed has been described by means of specific embodiments, numerous modifications and variations could be made thereto by those skilled in the art without departing from the scope and spirit of the invention set forth in the claims.

What is claimed is:

1. An optical computer mouse comprising:
a casing comprising a curved top including a front clickable left button, a front clickable right button parallel to the left button, and a touch sensitive member extending rearward from the right and left buttons, the touch sensitive member including a plurality of virtual buttons which are sensitive to touch;
a capacitive sensor assembly mounted under the touch sensitive member and comprising a first conductive layer and a second conductive layer, each of the first and second conductive layers being flexible and curved;
a PCB (printed circuit board) comprising an optical sensor electrically connected thereto, the optical sensor being responsive to diffuse light reflected from a desk top with the optical computer mouse rested thereon;
a scroll wheel mounted on the PCB and electrically connected thereto, the scroll wheel projecting out of the casing so that the scroll wheel is operable to rotate to move a mouse pointer on a screen of a computer system being operated by the optical computer mouse;
two contact switches mounted on the PCB and electrically connected thereto, the contact switches being disposed under the right and left buttons respectively so that either one of the right and left buttons is operable to press to create an output by contacting either contact switch;
a base releasably secured to the casing to assemble the optical computer mouse; and
an optical element mounted on a top of the base.

2. The optical computer mouse of claim 1, wherein the first conductive layer comprises a plurality of first sensor zones arranged in a plurality of rows, and the second conductive layer comprises a plurality of second sensor zones arranged in a plurality of rows, the first and second conductive layers being disposed under the virtual buttons so that one of the virtual buttons is operable to press to change a capacitance of each of the first and second conductive layers to create an output.

3. The optical computer mouse of claim 1, wherein each of the virtual buttons is printed with a unique function key or number.

4. The optical computer mouse of claim 1, wherein the touch sensitive member is formed of an optically transmissive material and the capacitive sensor assembly is formed of an optically transmissive material.

5. The optical computer mouse of claim 1, wherein the optical sensor comprises an LED (light-emitting diode) as a light source for emitting light toward the desk top, and a light sensitive member which is responsive to diffuse light reflected from the desk top.

6. The optical computer mouse of claim 5, wherein the base comprises an opening with the optical element mounted thereon so that light emitted by the LED passes the optical element and the opening of the base to reach the desk top, light reflects from the desk top to the light sensitive member via the optical element, and an output is created by the light sensitive member.

7. The optical computer mouse of claim 1, wherein the touch sensitive member is formed of an optically transmissive material, the capacitive sensor assembly is formed of an optically transmissive material, and the PCB further comprises a light source unit so as to configure the casing as one capable of emitting background light.
